(19) United States
(12) Patent Application Publication
(10) Pub. No.: US 2017/0274620 A1
(43) Pub. Date: Sep. 28, 2017

(54) RECORDING MEDIUM AND IMAGE FORMING APPARATUS

(71) Applicant: FUJI XEROX CO., LTD., Tokyo (JP)

(72) Inventors: Tsubasa NISHINO, Kanagawa (JP); Takeshi TAKEI, Kanagawa (JP); Katsumi HARADA, Kanagawa (JP)

(73) Assignee: FUJI XEROX CO., LTD., Tokyo (JP)

(21) Appl. No.: 15/220,929

(22) Filed: Jul. 27, 2016

(30) Foreign Application Priority Data
Mar. 28, 2016 (JP) 2016-063455

(51) Int. Cl. B32B 7/06; B32B 3/26; B32B 7/12; G03G 15/00

(52) U.S. Cl. CPC B32B 7/06; G03G 15/6529; B32B 3/266; B32B 7/12; B32B 2307/748; B32B 2307/75; B32B 2457/08; B32B 2425/00

(57) ABSTRACT

Provided is a recording medium including a first base material that is sent into an image forming apparatus to form an image and has a first adhesive layer, a second base material that has a second adhesive layer to be bonded to the first adhesive layer, and at least one storage member that is disposed between the first adhesive layer and the second adhesive layer, wherein a slit surrounds at least the storage member and has a depth from the first base material to the second adhesive layer, and wherein the storage member is provided at a side to be sent later into the image forming apparatus in a region surrounded by the slit.

### CROSS-REFERENCE TO RELATED APPLICATIONS

This application is based on and claims priority under 35 USC 119 from Japanese Patent Application No. 2016-063455 filed Mar. 28, 2016.

### BACKGROUND

Technical Field

The present invention relates to a recording medium and an image forming apparatus.

### SUMMARY

According to an aspect of the invention, there is provided a recording medium including:

a first base material that is sent into an image forming apparatus to form an image and has a first adhesive layer;

a second base material that has a second adhesive layer to be bonded to the first adhesive layer; and

at least one storage member that is disposed between the first adhesive layer and the second adhesive layer,

wherein a slit surrounds at least the storage member and has a depth from the first base material to the second adhesive layer, and

wherein the storage member is provided at a side to be sent later into the image forming apparatus in a region surrounded by the slit.

### BRIEF DESCRIPTION OF THE DRAWINGS

Exemplary embodiments of the present invention will be described in detail based on the following figures, wherein:

FIG. 1 is a side sectional view illustrating an image forming apparatus according to an exemplary embodiment;

FIG. 2 is a plan view illustrating a recording medium according to an exemplary embodiment;

FIG. 3 is a sectional view illustrating the recording medium according to the exemplary embodiment;

FIG. 4A is a schematic view illustrating a recording medium according to a comparative example, in which the recording medium is transported in an opposite direction;

FIG. 4B is a schematic view illustrating a state in which the recording medium is transported; and

FIG. 4C is a schematic view illustrating another state in which the recording medium is transported.

### DETAILED DESCRIPTION

Hereinafter, exemplary embodiments of the present invention will be described with reference to the accompanying drawings. The exemplary embodiments illustrated in the following illustrate a recording medium and an image forming apparatus that implement the technical sprit of the present invention, but are not intended to limit the present invention, may be equally applied to other exemplary embodiments that belong to the scope of the claims.

### Exemplary Embodiment

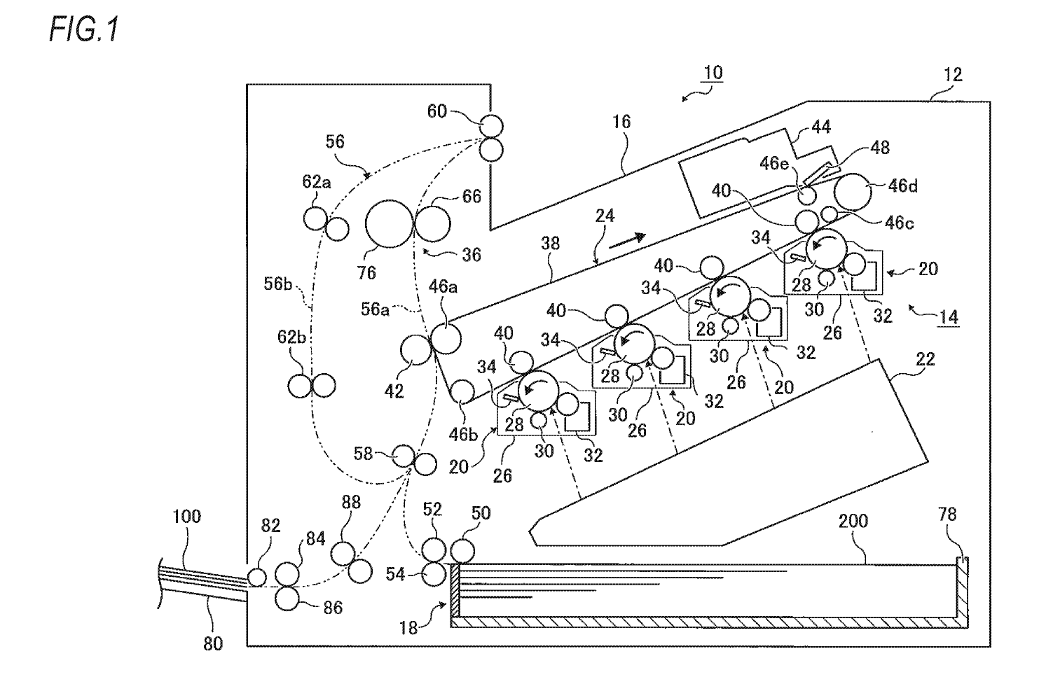

As illustrated in FIG. 1, an image forming apparatus 10 of an exemplary embodiment includes an image forming apparatus body 12. A recording medium 100 of the exemplary embodiment is disposed on aside (left side of FIG. 1) of the image forming apparatus body 12. A manual feed unit 80 is provided as an opening and closing device to send the recording medium into the image forming apparatus body 12. Further, a sheet feeding unit 18, an image forming unit 14, and a fixing device 36 are installed in the image forming apparatus body 12. The sheet feeding unit 18 feeds another recording medium 200, such as recording sheet, different from a recording medium of an exemplary embodiment. The image forming unit 14 forms an image that is to be transferred to the recording medium 100 and the another recording medium 200. A discharge section 16 is provided on an upper portion of the image forming apparatus body 12 to discharge the recording medium 100 and the another recording medium 200. A transport path 56 is provided to transport the recording medium 100 and the another recording medium 200, thereby causing the recording medium and another recording medium to pass through the above-mentioned components. (Hereinafter, the recording medium according to the exemplary embodiment is simply referred to as the “recording medium 100,” and the recording medium different from the recording medium of the exemplary embodiment is referred to as a “second recording medium 200.” Further, the recording medium 100 and the second recording medium 200 are collectively referred to as the “recording media 100 and 200.”) Further, the second recording medium 200 may be disposed on the manual feed unit 80.

The manual feed unit 80 of the image forming apparatus body 12 is configured such that the recording medium 100 fed from the manual feed unit 80 side in the image forming apparatus body 12 is placed in an opened state (see FIG. 1), and is received in a side surface of the image forming apparatus body 12 in a closed state (not illustrated).

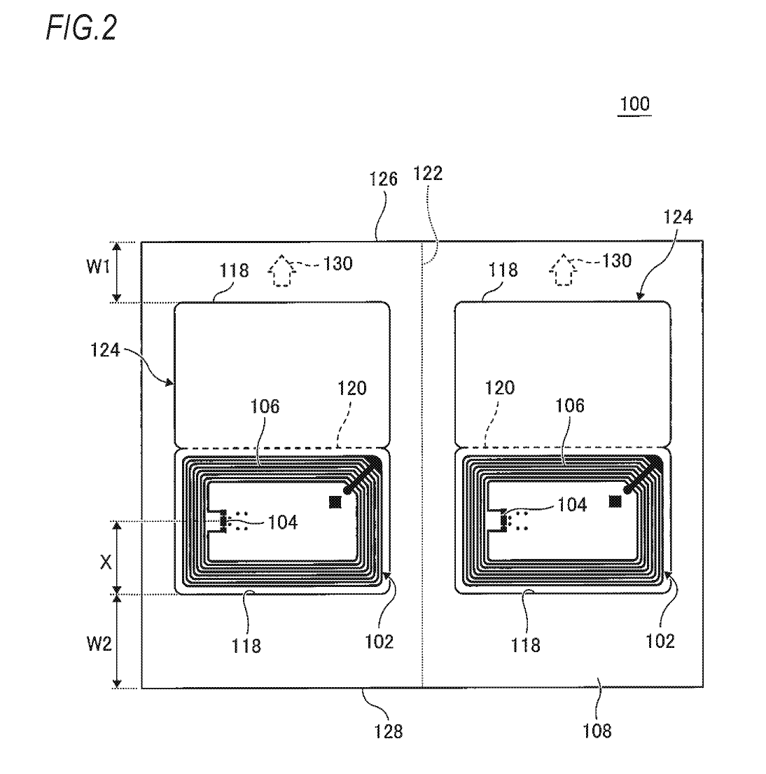

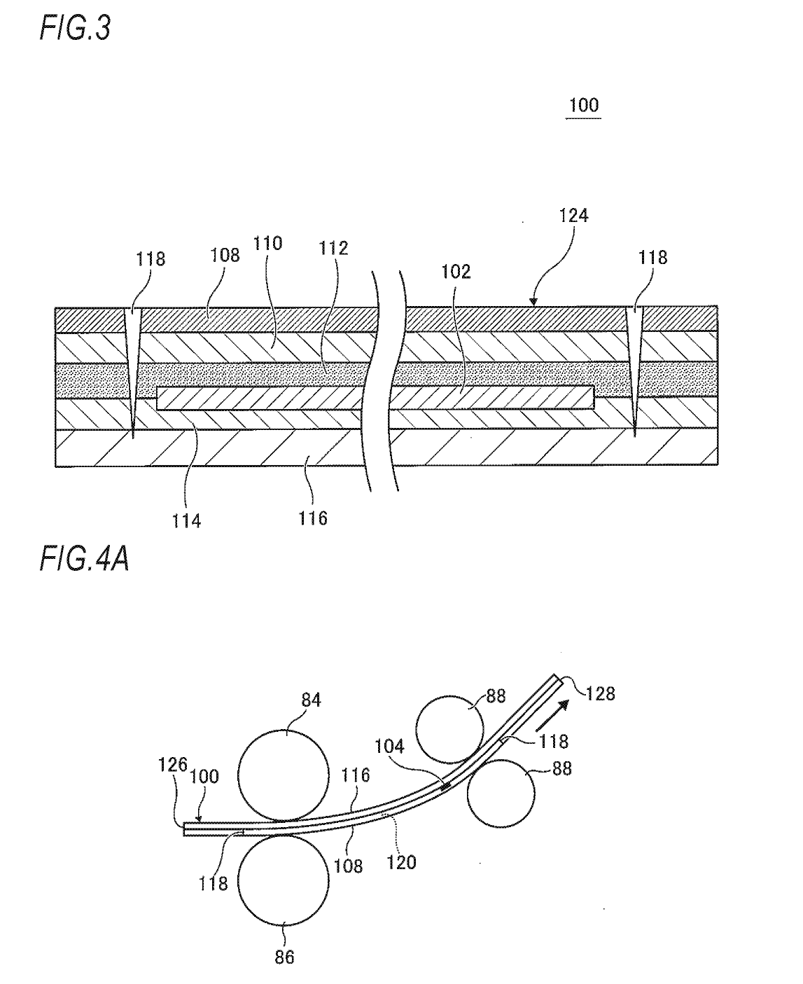

Here, the recording medium 100 of the exemplary embodiment will be described with reference to FIGS. 2 and 3.

The recording medium 100 of the exemplary embodiment has a rectangular shape with long and short sides. The recording medium includes, on one side, a first adhesive layer 112 as one base material, a base material layer 110 containing, for example, a resin material, and a coating layer 108 that is formed with an image, in this order from the circuit devices 102, and includes, on the other side, a second adhesive layer 114 as another base material, and a release paper 116 coated with the second adhesive layer 114 and serving as a release member having a detachable surface of the second adhesive layer 114, which are laminated in this order from the circuit devices 102, with plural (e.g., two (2)) circuit devices 102 interposed therebetween. Here, the first adhesive layer 112 on one side of the circuit devices 102 and the second adhesive layer 114 on the other side of the circuit devices 102 are configured to be attached to each other. Further, FIG. 2 illustrates the circuit devices 102 to be visible for the purpose of description.

The circuit device 102 includes a storage member 104, such as an IC (Integrated Circuit) that stores data, such as various pieces of information or records, and a coil type transceiver 106 which is connected to the storage member 104 to transmit and receive data and around which plural metal wires is wound. The transceiver 106 receives electric waves from an opponent, and also serve as a part of generating an electromotive force.

The recording medium 100 of the exemplary embodiment has a slit 118 that is formed to surround a predetermined range including the circuit device 102. This slit 118 is formed from a surface of one side of the recording medium 100 that is formed with an image to the second adhesive layer 114 of the other side. The release paper 116 is not cut. In the recording medium 100 of the exemplary embodiment, rectangular slits 118 are formed in two places on one recording medium 100. A part surrounded by each slit 118 becomes a release part 124. In the exemplary embodiment, the slit 118 is formed in a rectangular shape whose longitudinal direction is a direction in which the recording medium 100 is sent into the image forming apparatus body 12.

The release parts 124 surrounded by the slits 118 are spaced apart from each other, with a vertical perforation line 122 being provided therebetween.

In addition, while the release parts 124 surrounded by the slits 118 are spaced apart from each other in FIG. 2, both the slits of adjacent parts may integrally overlap each other without being limited thereto.

Further, a perforation line 120 is formed at a position of bisecting each release part 124 surrounded by each slit 118 in the transverse direction of the recording medium 100. Here, the circuit device 102 is disposed on one of the portions bisected from each release part 124 by the perforation line 120.

More specifically, assuming that a side of the recording medium 100 that is sent first into the image forming apparatus 10 is a front end 126 and a side of the recording medium that is opposite to the front end 126 and is sent later into the image forming apparatus 10 is a rear end 128, the storage member 104 of each circuit device 102 is located at one of the release parts 124 of the rear end 128 side of the recording medium 100 according to the exemplary embodiment, as illustrated in FIG. 2.

In addition, the storage member 104 is located at a position where a distance X between the storage member and the slit 118 on the rear end 128 of the recording medium 100 is shorter than a distance Y between a manual feeding roll 84 and a manual retard roll 86 and transport rolls 88 in the image forming apparatus body 12, which will be described below.

Further, a width W2 between the rear end 128 of the recording medium 100 and the slit 118 on the rear end 128 is formed to be greater than a width W1 between the front end 126 of the recording medium 100 and the slit 118 on the front end 126.

The recording medium 100 is configured such that, after an image is formed on the coating layer 108 by the image forming apparatus 10, the coating layer 108, the base material layer 110, the first adhesive layer 112, the circuit device 102, and the second adhesive layer 114 of the release part 124 surrounded by the slit 118 may be released from the release paper 116.

In addition, the released release part 124 is folded along the perforation line 120 such that the second adhesive layers 114 face each other, and then the second adhesive layers 114 are bonded to each other, thereby forming a card member. When the coating layers, each of which is formed with an image, are placed on both sides, a card member with images formed on both sides thereof is obtained.

Further, the recording medium 100 is placed on the manual feed unit 80, which will be described later, of the image forming apparatus 10, and then sent to the inside of the image forming apparatus body 12.

Here, a direction in which the recording medium 100 of the exemplary embodiment is placed on the manual feed unit 80 of the image forming apparatus 10 is defined, and the recording medium 100 is placed on the manual feed unit 80 such that the side provided with the circuit device 102 in each of the release parts 124 of the recording medium 100 is sent later. That is, the recording medium 100 is placed on the manual feed unit 80 such that the side of the recording medium 100 on which the storage members 104 are arranged becomes a position distant from the image forming apparatus body 12 on the manual feed unit 80. Further, a mark 130 may be provided on the recording medium 100 in order to indicate a position and a direction where the recording medium 100 is placed on the manual feed unit 80. The mark 130 is formed on a surface of the release paper 116 opposite to the coating layer 108 on which the image of the recording medium 100 is formed. This is because the coating layer 108 having the image thereon is disposed on the manual feed unit 80 to face downward, in the recording medium 100 of the exemplary embodiment, as will be described later.

In addition, the recording medium 100 is placed on the manual feed unit 80 such that the coating layer 108 on which the image is formed faces downward.

In addition, a paper material on which an image may be formed may be used on the image-formed side of the recording medium may use without being limited to a case where the coating layer is formed on the base material layer.

Next, respective components of the image forming apparatus according to the exemplary embodiment will be described with reference to FIG. 1.

The sheet feeding unit 18 includes a sheet feeding cassette 78 that receives the second recording mediums 200 in a stacked state, a pickup roll 50 that extracts the uppermost recording medium 200 received in the sheet feeding cassette 78, a supply roll 52 that supplies the extracted recording medium 200 toward the image forming unit 14, and a retard roll 54 that processes the second recording medium 200 such that plural second recording media 200 are transported to the image forming unit 14 in a superimposed state.

The image forming unit 14 includes image forming units 20 corresponding to four colors, for example, yellow (Y), magenta (M), cyan (C), and black (K), an optical recording device 22, and a transfer device 24. The image forming units 20 and components thereof are configured to equal to each other, except for the colors of images to be formed.

Each of the image forming units 20 is used as a replacement member, and is detachably provided on the image forming apparatus body 12. The image forming units 20 are arranged side by side in the order of Y, M, C and K from the back side (right side of FIG. 1) of the image forming apparatus body 12.

The image forming units 20 are of, for example, an electrophotographic type that forms color images. Each image forming unit 20 includes an image forming unit body 26, which is provided therein with: a drum-shaped image holder 28 that holds a developer image; a charging device 30 that serves as a charging unit that has a charging roll to cause the image holder 28 to be uniformly charged; a developing device 32 that develops a latent image recorded in the image holder 28 with a developer (toner); and a cleaning device 34 that collects and cleans a waste developer remaining in the image holder 28.

The developing devices 32 develop latent images formed on the corresponding image holders 28, using the developers of Y, M, C and K that are received in the developing devices, respectively.

The optical recording device 22 is used as a latent image forming unit, includes, for example, a scanning laser exposure device, and forms a latent image on the surface of each of the image holders 28. Further, the optical recording device 22 may employ an LED, a vertical cavity surface emitting laser or the like, in another example.

The transfer device 24 includes a transferred member 38 used as a transfer body, a primary transfer roll 40 used as a primary transfer device, a secondary transfer roll 42 used as a secondary transfer device, and a cleaning device 44.

The transferred member 38 has, for example, an endless belt shape, and is supported to be rotatable in a direction illustrated by the arrow in FIG. 1, by five (5) support rolls 46a, 46b, 46c, 46d, and 46e. Further, at least one of the support rolls 46a, 46b, 46c, 46d and 46e is connected to a power source (not illustrated) such as a motor, and is rotated by power transmitted from the power source, thereby causing the transferred member 38 to be rotationally driven.

The support roll 46a is disposed to be opposite to the secondary transfer roll 42 to serve as a backup roll of the secondary transfer roll 42. A portion interposed between the secondary transfer roll 42 and the support roll 46a becomes a secondary transfer position.

The primary transfer rolls 40 transfer developer images, which are formed on the surfaces of the image holders 28 by the corresponding developing devices 32, respectively, to the transferred member 38.

Further, the secondary transfer roll 42 transfers the developer images of Y, M, C and K transferred to the transferred member 38 to the recording media 100 and 200.

The cleaning device 44 has a scraper 48 that scrapes out the developer of each color remaining on the surface of the transferred member 38 after the developer image of each color is transferred to the recording media 100 and 200 using the secondary transfer roll 42. The developer scraped out by the scraper 48 is collected in a body of the cleaning device 44.

The transport path 56 includes a main transport path 56a and a reverse transport path 56b.

The main transport path 56a transports the recording medium 100, fed from the sheet feeding unit 18 or the manual feed unit 80, to the image forming unit 14, and then discharges the recording media 100 and 200 having an image formed thereon to the discharge section 16.

In the case where the second recording medium 200 is sent from the sheet feeding unit 18 to the main transport path 56a, the pickup roll 50, the supply roll 52, the retard roll 54, registration rolls 58, the transfer device 24, the fixing device 36, and exit rolls 60 are arranged in this order from the upstream side in the transport direction.

The pickup roll 50 delivers the second recording medium 200 from the sheet feeding cassette 78 of the sheet feeding unit 18. The delivered recording medium 200 is processed by the supply roll 52 and the retard roll 54 and guided into the main transport path 56a by the transport rolls 88.

Meanwhile, when the recording medium 100 is sent from the manual feed unit 80 to the main transport path 56a, the recording medium 100 is delivered from the manual feed unit 80 at the upstream side of the transport direction by a manual pickup roll 82. The delivered recording medium 100 is separated by the manual feeding roll 84 and the manual retard roll 86 as one side feeding members, and is guided to the transport path 56a by the transport rolls 88 as the other side feeding members. The transport of the recording medium 100 according to the exemplary embodiment from the manual feed unit 80 will be described below in detail.

The registration rolls 58 temporarily stop the front ends of the recording media 100 and 200 transported from the sheet feeding unit 18, and deliver the recording media 100 and 200 toward the transfer device 24 to coincide with the timing of forming the image.

The fixing device 36 includes a heating roll 66 and a pressurizing unit 76 as a heating unit, and heats and pressurizes the recording media 100 and 200 that pass between the heating roll 66 and the pressurizing unit 76 such that the developer image is fixed to the recording media 100 and 200.

The exit rolls 60 discharge the recording media 100 and 200 to which the developer is fixed by the fixing device 36 to the discharge section 16.

Further, the reverse transport path 56b is a transport path that reverses the second recording medium 200 having the developer image on a surface thereof, and then feeds the recording medium toward the image forming unit 14 again. For example, two reverse transport rolls 62a and 62b are disposed on the reverse transport path 56b. The recording medium 100 of the exemplary embodiment is configured such that an image is formed only on one surface.

The second recording medium 200 is transported from the main transport path 56a to the exit rolls 60, and the exit rolls 60 is rotated in reverse in the state where the rear end of the second recording medium 200 is sandwiched between the exit rolls 60, so that the second recording medium 200 is fed to the reverse transport path 56b. The second recording medium 200 fed to the reverse transport path 56b is transported to the upstream position of the registration rolls 58, by the reverse transport rolls 62a and 62b.

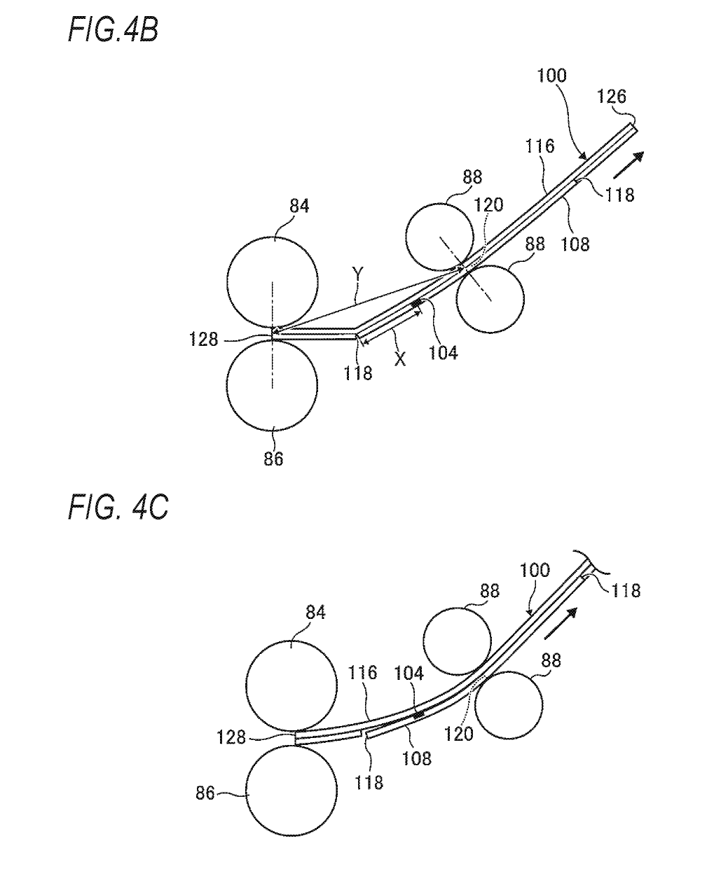

Next, the transport of the recording medium 100 by the image forming apparatus 10 according to the exemplary embodiment will be described with reference to FIG. 1 and FIGS. 4A to 4C. As described above, the recording medium 100 of the exemplary embodiment is provided with the circuit device 102 with the storage member 104.

When an image is formed on the recording medium 100 of the exemplary embodiment using the image forming apparatus 10, first, the recording medium 100 is placed on the manual feed unit 80. The recording medium 100 is placed such that the coating layer 108 of the recording medium 100 on which the image is to be formed faces downward, that is, toward the manual feed unit 80. Since the coating layer 108 of the recording medium 100 is placed downward, the slit 118 formed in the recording medium 100 is likewise placed downward.

In the release part 124 of the recording medium 100, the rear end 128 of the recording medium 100 having the circuit device 102 is placed on the manual feed unit 80 to be at a rear position of the image forming apparatus body 12. That is, the rear end 128 of the recording medium 100 having the circuit device 102 of the recording medium 100 is placed to be sent later into the image forming apparatus body 12. The recording medium of the exemplary embodiment has the mark 130, such as an arrow such that no mistake is made in orientation and direction.

Subsequently, the recording medium 100 is sent from the manual feed unit 80 into the image forming apparatus body 12. Thereby, as described above, the recording medium 100 is delivered to the manual pickup roll 82, separated by the manual feeding roll 84 and the manual retard roll 86, and then guided into the main transport path 56a by the transport rolls 88.

As illustrated in FIG. 4A, the recording medium is transported while being bent to a sharp angle between the manual feeding roll 84 and the manual retard roll 86 and the transport rolls 88. Therefore, when the rear end 128 of the recording medium 100 having the storage member 104 is first sent (i.e. when the front end 126 of the recording medium 100 is sent later), the recording medium 100 is bent to be curved during the transport, so that there is a possibility that a large load is exerted especially on the storage member 104 of the circuit device 102.

However, the recording medium 100 of the exemplary embodiment is configured such that the storage member 104 of the circuit device 102 is sent later, and the distance X between the storage member 104 provided on the recording medium 100 and the slit 118 on the rear end 128 of the recording medium 100 is shorter than the distance Y between the manual feeding roll 84 and the manual retard roll 86, and the transport rolls 88.

In the case where the recording medium 100 passes between the manual feeding roll 84 and the manual retard roll 86 and the transport rolls 88, as illustrated in FIG. 4B, stress is applied to the recording medium 100 so as to cause the slit 118 on the rear end 128 of the recording medium 100 to be bent. Thus, the bent curvature of the recording medium 100 is decreased.

Therefore, when the recording medium 100 passes between the manual feeding roll 84 and the manual retard roll 86 and the transport rolls 88, it is possible to prevent stress from being concentrated on the storage member 104.

In addition, as illustrated in FIG. 4C, since the rear end 128 of the recording medium 100 having the storage member 104 is transported later, the second adhesive layer 114 and the release paper 116 in the slit 118 on the rear end 128 of the bent recording medium 100 are partially released. Therefore, even if the slit 118 on the rear end 128 side of the recording medium 100 is bent less to be increased in curvature, the slit 118 is released so that it is possible to suppress a portion, which is provided with the storage member 104, from being excessively curved.

After the recording medium 100 passes between the transport rolls 88, as described above, an image is formed. Thereafter, the recording medium is discharged to the discharge section 16. In this way, the image formation is completed.

Further, in the image forming apparatus 10, the distance Y between the manual feeding roll 84 and the manual retard roll 86 and the transport rolls 88 in the image forming apparatus body 12 may be set to be longer than the distance X between the storage member 104 of the circuit device 102 of the recording medium 100 and the slit 118 on the rear end 128 of the recording medium 100.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A recording medium comprising:
a first base material that is sent into an image forming apparatus to form an image and has a first adhesive layer;
a second base material that has a second adhesive layer to be bonded to the first adhesive layer; and
at least one storage member that is disposed between the first adhesive layer and the second adhesive layer,
wherein a slit surrounds at least the storage member and has a depth from the first base material to the second adhesive layer, and
wherein the storage member is provided at a side to be sent later into the image forming apparatus in a region surrounded by the slit.

2. The recording medium according to claim 1,
wherein a distance between the storage member and the slit on the side to be sent later into the image forming apparatus is shorter than a distance between a first feeding member that is provided on a transport path in the image forming apparatus and a second feeding member that is located at a downstream side of the transport path and is adjacent to the first feeding member.

3. The recording medium according to claim 2,
wherein the transport path between the first feeding member and the second feeding member has a curved shape, and
wherein a side formed with the slit is disposed on a curved outer side of the transport path, so that the recording medium is bent along the slit of the side to be sent later into the image forming apparatus when the recording medium passes through the transport path between the first feeding member and the second feeding member.

4. The recording medium according to claim 2,
wherein the second base material includes the second adhesive layer, and a release member to which the second adhesive layer is detachably applied, and
wherein the second adhesive layer and the release member are released from each other in the slit on the storage member side when the recording medium passes through the transport path between the first feeding member and the second feeding member.

5. The recording medium according to claim 3,
wherein the second base material includes the second adhesive layer, and a release member to which the second adhesive layer is detachably applied, and
wherein the second adhesive layer and the release member are released from each other in the slit on the storage member side when the recording medium passes through the transport path between the first feeding member and the second feeding member.

6. The recording medium according to claim 1,
wherein the first base material includes:
the first adhesive layer;
a base material layer that contains a resin material; and
a coating layer that is provided on at least a side to be formed with an image on the base material layer.

7. The recording medium according to claim 2,
wherein the first base material includes:
the first adhesive layer;
a base material layer that contains a resin material; and
a coating layer that is provided on at least a side to be formed with an image on the base material layer.

8. The recording medium according to claim 3,
wherein the first base material includes:
the first adhesive layer;
a base material layer that contains a resin material; and
a coating layer that is provided on at least a side to be formed with an image on the base material layer.

9. The recording medium according to claim 4,
wherein the first base material includes:
the first adhesive layer;
a base material layer that contains a resin material; and
a coating layer that is provided on at least a side to be formed with an image on the base material layer.

10. The recording medium according to claim 1,
wherein a margin is provided outside a region surrounded by the slit, and
wherein the margin at the side to be sent later into the image forming apparatus is wider than the margin at a side to be sent first into the image forming apparatus.

11. The recording medium according to claim 2,
wherein a margin is provided outside a region surrounded by the slit, and
wherein the margin at the side to be sent later into the image forming apparatus is wider than the margin at a side to be sent first into the image forming apparatus.

12. The recording medium according to claim 3,
wherein a margin is provided outside a region surrounded by the slit, and
wherein the margin at the side to be sent later into the image forming apparatus is wider than the margin at a side to be sent first into the image forming apparatus.

13. The recording medium according to claim 4,
wherein a margin is provided outside a region surrounded by the slit, and
wherein the margin at the side to be sent later into the image forming apparatus is wider than the margin at a side to be sent first into the image forming apparatus.

14. The recording medium according to claim 6,
wherein a margin is provided outside a region surrounded by the slit, and
wherein the margin at the side to be sent later into the image forming apparatus is wider than the margin at a side to be sent first into the image forming apparatus.

15. The recording medium according to claim 1,
wherein a mark is provided at a side to be sent first into the image forming apparatus.

16. The recording medium according to claim 2,
wherein a mark is provided at a side to be sent first into the image forming apparatus.

17. The recording medium according to claim 3,
wherein a mark is provided at a side to be sent first into the image forming apparatus.

18. The recording medium according to claim 4,
wherein a mark is provided at a side to be sent first into the image forming apparatus.

19. The recording medium according to claim 6,
wherein a mark is provided at a side to be sent first into the image forming apparatus.

20. An image forming apparatus comprising:
an image forming apparatus body;
a transport path that transports a recording medium,
the recording medium including:
a first base material that is sent into the image forming apparatus body to form an image and has a first adhesive layer;
a second base material that has a second adhesive layer to be bonded to the first adhesive layer; and
at least one storage member that is disposed between the first adhesive layer and the second adhesive layer, in which a slit surrounds at least the storage member and has a depth from the first base material to the second adhesive layer, the storage member being provided at a side to be sent later into the image forming apparatus in a region surrounded by the slit;
a first feeding member that is provided on the transport path; and
a second feeding member that is provided adjacent to the first feeding member at a downstream side of the transport path,
wherein a distance between the first feeding member and the second feeding member is longer than a distance between the slit of the side of the recording medium to be sent later into the image forming apparatus and the storage member.
